(19) United States
(12) Patent Application Publication
(10) Pub. No.: US 2013/0160750 A1
(43) Pub. Date: Jun. 27, 2013

(54) ABNORMALITY DETERMINATION SYSTEM FOR INTERNAL COMBUSTION ENGINE, AND ABNORMALITY DETERMINING METHOD FOR INTERNAL COMBUSTION ENGINE

(71) Applicant: Kenya Maruyama, Nissin-shi (JP)

(72) Inventor: Kenya Maruyama, Nissin-shi (JP)

(21) Appl. No.: 13/721,652

(22) Filed: Dec. 20, 2012

(30) Foreign Application Priority Data
Dec. 21, 2011 (JP) 2011-279841

(51) Int. Cl. F02M 25/07; F02B 47/08

(52) U.S. Cl. CPC F02M 25/0753; F02B 47/08
USPC 123/568.21

(57) ABSTRACT

An abnormality determination system for an internal combustion engine includes a plurality of EGR gas supply sections, an EGR gas supply control unit, an air-fuel ratio sensor placed downstream of an exhaust collecting portion, and an abnormality determining unit that determines an abnormality in the internal combustion engine. The abnormality determining unit obtains a change rate corresponding value during shutoff of the EGR gas or during supply of the EGR gas, as an EGR-OFF corresponding value or an EGR-ON corresponding value. The abnormality determining unit obtains a normalized EGR-OFF corresponding value, and obtains a normalized EGR-ON corresponding value. The abnormality determining unit makes an abnormality determines whether one of the EGR gas supply sections is in an abnormal condition in which the EGR gas supply section is blocked, based on a relationship between the normalized EGR-OFF corresponding value and the normalized EGR-ON corresponding value.

### INCORPORATION BY REFERENCE

The disclosure of Japanese Patent Application No. 2011-279841 filed on Dec. 21, 2011 including the specification, drawings and abstract is incorporated herein by reference in its entirety.

### BACKGROUND OF THE INVENTION

1. Field of the Invention

The invention relates to an abnormality determination system and the abnormality determining method for an internal combustion engine, which can accurately determine the occurrence of an abnormality in an EGR (exhaust gas recirculation) system.

2. Description of the Related Art

There is known an EGR system for recirculating exhaust gas emitted from respective cylinders of the engine into the respective cylinders, through one common EGR gas passage, and individual EGR gas supply sections (including EGR gas supply ports) that correspond to the respective cylinders and diverge from the common EGR gas passage. In the EGR system, if one of the EGR gas supply sections corresponding to any of the cylinders is blocked or clogged, the air-fuel ratio of an air-fuel mixture supplied to the cylinder corresponding to the blocked EGR supply section becomes leaner than the air-fuel ratio of air-fuel mixtures supplied to the other cylinders. Accordingly, the air-fuel ratios of the mixtures supplied to the respective cylinders become imbalanced, which may cause deterioration of emissions. The “abnormal condition in which any of the EGR gas supply sections is blocked” will be referred to as “blocked, abnormal condition of the EGR gas supply section” in this specification and the appended claims when appropriate.

It may be determined whether any of the EGR gas supply sections is in a blocked, abnormal condition, by monitoring the air-fuel ratio (which will be called “detected air-fuel ratio”) represented by an output value of an air-fuel ratio sensor placed in an exhaust collecting portion into which exhaust gas is collected or an exhaust passage downstream of the exhaust collecting portion.

More specifically, the amount of change of the detected air-fuel ratio per unit time (which will be called “rate of change of the air-fuel ratio” or “air-fuel ratio change rate”) in a condition in which supply of EGR gas to each cylinder is stopped is obtained, and the air-fuel ratio change rate is also obtained in a condition in which EGR gas is supplied to each cylinder. In the following, the condition in which supply of EGR gas to each cylinder is stopped will be called “EGR-gas shutoff condition”, and the condition in which EGR gas is supplied to each cylinder will be called “EGR-gas supply condition”.

The detected air-fuel ratio varies with time in accordance with changes in the air-fuel ratios of exhaust gases emitted from the respective cylinders. In the case where no abnormality occurs (namely, where the engine is in normal conditions), the air-fuel ratios of exhaust gases emitted from the respective cylinders are substantially equal to each other. Accordingly, as shown in FIG. 1, when the engine is in normal conditions, “the average value AveΔAFoff of the magnitude (=slope α1) of the air-fuel ratio change rate ΔAFoff in the EGR-gas shutoff condition” is substantially equal to “the average value AveΔAFon of the magnitude (=slope α2) of the air-fuel ratio change rate ΔAFon in the EGR-gas supply condition”. Namely, the ratio Kkairi (=AveΔAFon/AveΔAFoff) of the average value AveΔAFon to the average value AveΔAFoff is substantially equal to 1.

On the other hand, if any of the EGR gas supply sections is brought into a blocked, abnormal condition, extra air (new air), in place of EGR gas, flows into the cylinder corresponding to the blocked EGR gas supply section (including the EGR gas supply port). Therefore, the air-fuel ratio of this cylinder becomes leaner than the air-fuel ratios of the other cylinders. The shift of the air-fuel ratio to the lean side occurs when the EGR gas is supplied to the cylinders, but does not occur when the EGR gas is shut off. As a result, as shown in FIG. 1, when any of the EGR gas supply sections is in a blocked, abnormal condition, “the average value AveΔAFon of the magnitude (=slope α4) of the air-fuel ratio change rate ΔAFon in the EGR-gas supply condition” becomes significantly larger than “the average value AveΔAFoff of the magnitude (=slope α3) of the air-fuel ratio change rate ΔAFoff in the EGR-gas shutoff condition”. Namely, the above-indicated ratio Kkairi becomes significantly larger than 1.

In a system as described in International Publication WO2011/055463, for example, a parameter (e.g., AveΔAFoff) corresponding to the air-fuel ratio change rate ΔAFoff in the EGR-gas shutoff condition and a parameter (e.g., AveΔAFon) corresponding to the air-fuel ratio change rate ΔAFon in the EGR-gas supply condition are obtained, and it is determined whether an air-fuel ratio imbalance condition caused by EGR appears among cylinders, based on the difference (or deviation) between the parameters.

The air-fuel ratio change rate changes under the influences of the engine speed and the intake air amount. Accordingly, if the engine speed and the intake air amount in a period (first period) in which the air-fuel ratio change rates (basic data) corresponding to the average value AveΔAFoff were obtained are respectively different from the engine speed and the intake air amount in a period (second period) in which the air-fuel ratio change rates (basic data) corresponding to the average value AveΔAFon were obtained, it may not be accurately determined whether any of the EGR gas supply sections is in a blocked, abnormal condition when these values (the average value AveΔAFoff and the average value AveΔAFon) are simply compared with each other.

It may be proposed to limit an operating region of the engine in which the air-fuel ratio change rates (basic data) corresponding to the average value AveΔAFoff are obtained, and an operating region in which the air-fuel ratio change rates (basic data) corresponding to the average value AveΔAFon are obtained, to the same, narrow range. However, in this case, chances of obtaining air-fuel ratio change rates are reduced drastically. Accordingly, the determination as to whether any of the EGR gas supply sections is in a blocked, abnormal condition may be largely delayed.

### SUMMARY OF THE INVENTION

The invention provides an abnormality determination system for an internal combustion engine, which can accurately determine whether any of EGR gas supply sections is in a blocked, abnormal condition without long delay.

An abnormality determination system for an internal combustion engine according to a first aspect of the invention includes a plurality of EGR gas supply sections provided for at least two cylinders, respectively, of a plurality of cylinders included in a multi-cylinder internal combustion engine, the plurality of cylinders being arranged to emit exhaust gas into one exhaust collecting portion of an exhaust passage of the engine, the plurality of EGR gas supply sections being arranged to supply external EGR gas to respective combustion chambers of the above-indicated at least two cylinders, an EGR gas supply control unit that executes supply of the external EGR gas through the plurality of EGR gas supply sections when an operating condition of the engine satisfies a given EGR execution condition, and stops supply of the external EGR gas when the operating condition of the engine does not satisfy the given EGR execution condition, an air-fuel ratio sensor placed in the exhaust collecting portion or a portion of the exhaust passage downstream of the exhaust collecting portion, the air-fuel ratio sensor being operable to generate an output value that varies with an air-fuel ratio of exhaust gas in the exhaust collecting portion or the above-indicated portion of the exhaust passage, and an abnormality determining unit that determines an abnormality in the internal combustion engine. The abnormality determining unit obtains an amount of change in the output value of the air-fuel ratio sensor or a detected air-fuel ratio represented by the output value of the air-fuel ratio sensor per unit time, as basic data, and obtains a change rate corresponding value that varies according to the basic data, based on the basic data. The abnormality determining unit obtains an EGR-OFF corresponding value during shutoff of the EGR gas, as the change rate corresponding value obtained while the EGR gas is shut off, and obtains an EGR-ON corresponding value during supply of the EGR gas, as the change rate corresponding value obtained while the EGR gas is supplied. The abnormality determining unit obtains a normalized EGR-OFF corresponding value, by converting the obtained EGR-OFF corresponding value into an EGR-OFF corresponding value to be obtained when a rotational speed of the engine in a first period in which the basic data that provides the EGR-OFF corresponding value is obtained is equal to a particular engine speed, and an intake air amount of the engine in the first period is equal to a particular intake air amount, and obtains a normalized EGR-ON corresponding value, by converting the obtained EGR-ON corresponding value into an EGR-ON corresponding value to be obtained when the rotational speed of the engine in a second period in which the basic data that provides the EGR-ON corresponding value is obtained is equal to the particular engine speed, and the intake air amount of the engine in the second period is equal to the particular intake air amount. The abnormality determining unit makes an abnormality determination as to whether any of the EGR gas supply sections is in an abnormal condition in which the EGR gas supply section is blocked, based on a relationship in magnitude between the normalized EGR-OFF corresponding value and the normalized EGR-ON corresponding value.

In the system as described above, the basic data obtained as the amount of change in the output value of the air-fuel ratio sensor or the detected air-fuel ratio represented by the output value of the air-fuel ratio sensor, per unit time, is substantially equal to a time differential value of the output value of the air-fuel ratio sensor or a time differential value of the detected air-fuel ratio.

For example, the change rate corresponding value may be a value (the above-mentioned average value AveΔAFoff and average value AveΔAFon) obtained by averaging absolute values of the basic data over a specified period (e.g., a period it takes the crankshaft to rotate 720°), or a value obtained by averaging the average values obtained with respect to two or more specified periods, or the maximum value of the absolute values of a plurality of basic data obtained in the specified period, or a value obtained by averaging the maximum values obtained with respect to two or more specified periods. Namely, the change rate corresponding value may be any value that varies according to the basic data (or any value that increases as the magnitude of the basic data increases).

In the system as described above, the method of evaluating the relationship in magnitude between the normalized EGR-OFF corresponding value and the normalized EGR-ON corresponding value is not limited to any particular method. For example, the relationship in magnitude between the normalized EGR-OFF corresponding value and the normalized EGR-ON corresponding value may be evaluated by determining whether the ratio of the normalized EGR-ON corresponding value to the normalized EGR-OFF corresponding value, the reciprocal of the ratio, or a difference between the normalized EGR-OFF corresponding value and the EGR-ON corresponding value, for example, is equal to or larger than a corresponding threshold value.

With the above arrangement, the EGR-OFF corresponding value is converted into a value (i.e., normalized EGR-OFF corresponding value) obtained at the particular engine speed, with the particular intake air amount, and the EGR-ON corresponding value is converted into a value (i.e., normalized EGR-ON corresponding value) obtained at the particular engine speed, with the particular intake air amount. Then, the relationship in magnitude between the normalized EGR-OFF corresponding value and the normalized EGR-ON corresponding value is evaluated.

In other words, the normalized EGR-OFF corresponding value and the normalized EGR-ON corresponding value, which are used when determining whether any of the EGR gas supply sections is in a blocked, abnormal condition, are based on values that would be obtained when the basic data were obtained at the same particular engine speed and particular intake air amount. Accordingly, even when the engine speed and intake air amount in the period (first period) in which data (i.e., basic data) that provides a basis for calculation of the EGR-OFF corresponding value was obtained are different from the engine speed and intake air amount in the period (second period) in which data (i.e., basic data) that provides a basis for calculation of the EGR-ON corresponding value was obtained, it can be accurately determined whether any of the EGR gas supply sections is in an abnormal condition in which the supply section is blocked or clogged. Further, since there is no need to limit the operating regions in which the EGR-OFF corresponding value and the EGR-ON corresponding value are obtained, to a narrow range, it can be determined without long delay whether any of the EGR gas supply sections is in a blocked, abnormal condition.

The above-indicated abnormality determining unit may store, in advance, first conversion relationships that define relationships among the EGR-OFF corresponding value, the engine speed in the first period, the intake air amount in the first period, and the normalized EGR-OFF corresponding value, and may be configured to obtain the normalized EGR-OFF corresponding value used for making the abnormality determination, based on an actual engine speed in the first period in which the EGR-OFF corresponding value is actually obtained, an actual intake air amount in the first period in which the EGR-OFF corresponding value is actually obtained, the actually obtained EGR-OFF corresponding value, and the first conversion relationships. Also, the abnormality determining unit may store, in advance, second conversion relationships that define relationships among the EGR-ON corresponding value, the engine speed in the second period, the intake air amount in the second period, and the normalized EGR-ON corresponding value, and may be configured to obtain the normalized EGR-ON corresponding value used for making the abnormality determination, based on an actual engine speed in the second period in which the EGR-ON corresponding value is actually obtained, an actual intake air amount in the second period in which the EGR-ON corresponding value is actually obtained, the actually obtained EGR-ON corresponding value, and the second conversion relationships.

In the system as described above, the first conversion relationships and the second conversion relationships are obtained in advance by experiment, or the like.

With the abnormality determining unit configured as described above, the normalized EGR-OFF corresponding value and the normalized EGR-ON corresponding value can be obtained with a simple arrangement.

### BRIEF DESCRIPTION OF THE DRAWINGS

The features, advantages, and technical and industrial significance of this invention will be described in the following detailed description of exemplary embodiments of the invention with reference to the accompanying drawings, in which like numerals denote like elements, and wherein:

FIG. 1 is a table indicating a waveform of detected air-fuel ratio and parameters associated with abnormality determination in each condition of an internal combustion engine;

FIG. 2 is a schematic plan view of the internal combustion engine in which an abnormality determination system according to one embodiment of the invention is used;

FIG. 3 is a graph indicating the relationship between the air-fuel ratio of exhaust gas and output values of an air-fuel ratio sensor;

FIG. 4 is a flowchart illustrating the operation of the abnormality determination system according to this embodiment of the invention;

FIG. 5 is a flowchart illustrating a routine executed by CPU shown in FIG. 2;

FIG. 6 is a flowchart illustrating a routine executed by CPU shown in FIG. 2;

FIG. 7 is a flowchart illustrating a routine executed by CPU shown in FIG. 2;

FIG. 8 is a flowchart illustrating a routine executed by CPU shown in FIG. 2; and

FIG. 9 is a flowchart illustrating a routine executed by CPU shown in FIG. 2.

### DETAILED DESCRIPTION OF EMBODIMENTS

An abnormality determination system for an internal combustion engine according to one embodiment of the invention will be described with reference to the drawings. The determination system of this embodiment is a part of an air-fuel ratio control system that controls the air-fuel ratio of an air-fuel mixture supplied to the internal combustion engine, and is also a part of a fuel injection amount control system that controls the fuel injection amount and an EGR control system.

### (Configuration)

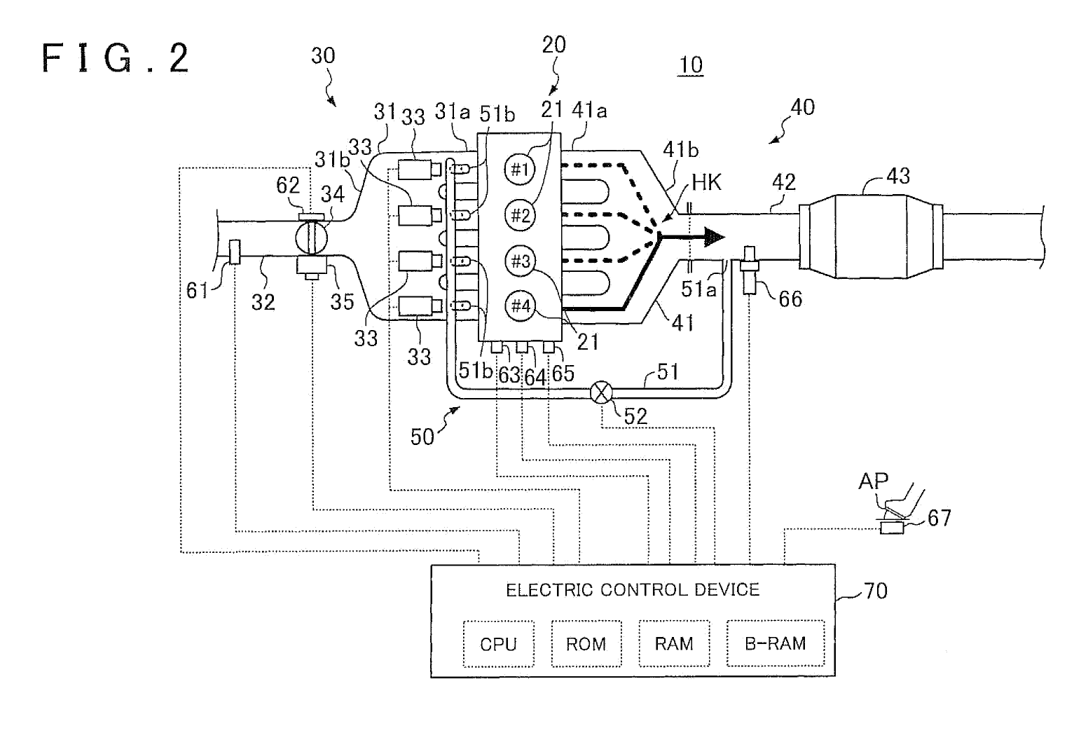

FIG. 2 schematically shows the configuration of a system in which the determination system of this embodiment is applied to a four-cycle, spark-ignition, multi-cylinder internal combustion engine 10 (in this embodiment, in-line four-cylinder engine). The internal combustion engine 10 includes an engine main body 20, an induction system 30, an exhaust system 40, and an EGR gas supply device 50.

The engine main body 20 includes a cylinder block portion and a cylinder head portion. The engine main body 20 has a plurality of cylinders (combustion chambers) 21. Each of the cylinders communicates with an intake port and an exhaust port, which are not illustrated. A communicating portion between the intake port and the combustion chamber 21 is opened and closed by an intake valve (not shown). A communicating portion between the exhaust port and the combustion chamber 21 is opened and closed by an exhaust valve (not shown). An ignition plug (not shown) is placed in each of the combustion chambers 21.

The induction system 30 includes an intake manifold 31, an intake pipe 32, a plurality of fuel injection valves 33, a throttle valve 34, and a throttle-valve actuator 35.

The intake manifold 31 includes a plurality of branch portions 31a and a surge tank 31b. One end of each of the branch portions 31a is connected to a corresponding one of the intake ports. The other ends of the branch portions 31a are connected to the surge tank 31b.

One end of the intake pipe 32 is connected to the surge tank 31b. An air filter (not shown) is placed at the other end of the intake pipe 32.

Each of the fuel injection valves 33 is provided for each of the cylinders (combustion chambers) 21. The fuel injection valves 33 are disposed in the intake ports. Namely, each of the cylinders is equipped with the fuel injection valve 33 for supplying fuel into the cylinder, independently of the other cylinders. The fuel injection valve 33, when it operates normally, injects and supplies fuel in a specified fuel injection amount, into the corresponding intake port (namely, a cylinder corresponding to the fuel injection valve 33), in response to an injection command signal including the specified fuel injection amount.

The throttle valve 34 is rotatably mounted in the intake pipe 32. The throttle valve 34 is operable to vary the cross-sectional area of the opening of the intake passage. The throttle valve 34 is rotated/driven by the throttle-valve actuator 35 in the intake pipe 32.

The exhaust system 40 includes an exhaust manifold 41, an exhaust pipe 42, an upstream-side catalyst 43 placed in the exhaust pipe 42, and a downstream-side catalyst (not shown) placed in the exhaust pipe 42 downstream of the upstream-side catalyst 43.

The exhaust manifold 41 includes a plurality of branch portions 41a and a collecting portion 41b. One end of each of the branch portions 41a is connected to a corresponding one of the exhaust ports. The other end of each of the branch portions 41a is connected to the collecting portion 41b. Exhaust gases emitted from the plurality of cylinders (four cylinders in this embodiment) are collected in the collecting portion 41b; therefore, the collecting portion 41b is also called “exhaust collecting portion HK”.

The exhaust pipe 42 is connected to the collecting portion 41b. The exhaust ports, exhaust manifold 41 and the exhaust pipe 42 constitute an exhaust passage.

Each of the upstream-side catalyst 43 and the downstream-side catalyst is a three-way catalytic converter (catalyst for purifying exhaust gas). Each of the catalysts has a function of oxidizing unburned components, such as HC, CO, and H₂ and reducing nitrogen oxides (NOx), when the air-fuel ratio of gas flowing into the catalyst is within a window of the three-way catalyst (for example, is equal to the stoichiometric air-fuel ratio). This function is also called “catalytic function”. Each of the catalysts also has an oxygen storage function of adsorbing (storing) oxygen. Owing to the oxygen storage function, each catalyst is able to convert or otherwise treat the unburned components and nitrogen oxides, even if the air-fuel ratio shifts or deviates from the stoichiometric air-fuel ratio. Namely, the width of the window of the catalyst is increased due to the oxygen storage function. The oxygen storage function is provided by an oxygen storage material, such as ceria (CeO₂), carried by the catalyst.

The EGR gas supply device 50 includes an exhaust recirculation pipe 51 that constitutes an external EGR passage, and an EGR control valve 52.

One end 51a of the exhaust recirculation pipe 51 is connected to the collecting portion 41b (exhaust collecting portion HK) of the exhaust manifold 41, or a position of the exhaust pipe 42 upstream of the upstream-side catalyst 43. The other end of the exhaust recirculation pipe 51 divides into the same number of branch portions as that of the cylinders. The branch portions are also called “EGR gas supply sections”. End portions of the branch portions are open, and form a plurality of EGR gas supply ports 51b. Each of the EGR gas supply ports 51b is placed in a corresponding one of the branch portions 31a of the intake manifold 31.

Namely, the EGR gas supply device 50 has a plurality of EGR gas supply sections including the EGR gas supply ports 51b, which correspond to at least two cylinders (preferably, three or more cylinders, or all cylinders in this embodiment), respectively, and external EGR gas is supplied to the combustion chambers 21 of the respective cylinders through the corresponding EGR gas supply sections. In this specification, external EGR gas that passes through the exhaust recirculation pipe 51 may be simply called “EGR gas”.

The EGR control valve 52 is placed in the exhaust recirculation pipe 51. The EGR control valve 52 incorporates a DC motor as a driving source. The EGR control valve 52 changes its valve opening in response to the duty ratio DEGR as a command signal to the DC motor, so as to change the cross-sectional area of a passage of the exhaust recirculation pipe 51. When the duty ratio DEGR is equal to 0, the EGR control valve 52 shuts off the exhaust recirculation pipe 51. At this time, the EGR gas supply device 50 is placed in an EGR-gas shutoff condition in which the EGR gas is not supplied to the combustion chambers 21. When the duty ratio DEGR is not equal to 0, the EGR control valve 52 increases the cross-sectional area of the passage of the exhaust recirculation pipe 51 as the duty ratio DEGR is larger. At this time, the EGR gas supply device 50 is placed in an EGR gas supply condition in which the EGR gas is supplied to the combustion chambers 21.

The system as shown in FIG. 2 includes a hot-wire air flow meter 61, throttle position sensor 62, water temperature sensor 63, crank position sensor 64, intake cam position sensor 65, air-fuel ratio sensor 66, and an accelerator position sensor 67.

The air flow meter 61 generates a signal indicative of the mass flow (or flow rate) Ga of intake air flowing in the intake pipe 32. The intake air amount Ga represents the amount of intake air drawn into the engine 10 per unit time.

The throttle position sensor 62 detects the opening of the throttle valve 34, and generates a signal indicative of the throttle opening TA.

The water temperature sensor 63 detects the temperature of the coolant of the internal combustion engine 10, and generates a signal indicative of the coolant temperature THW. The coolant temperature THW is a parameter representing a warm-up condition of the engine 10 (i.e., the temperature of the engine 10).

The crank position sensor 64 generates a signal having narrow pulses each produced each time the crankshaft rotates by 10° and wide pulses each produced each time the crankshaft rotates by 360°. The signal is converted to the engine speed NE by an electric control device 70 which will be described later.

The intake cam position sensor 65 produces one pulse each time an intake camshaft rotates 90 degrees, then 90 degrees, and further 180 degrees as measured from a given angle. The electric control device 70 as described later obtains an absolute crank angle CA relative to the compression top dead center of a reference cylinder (e.g., a first cylinder), based on the signals received from the crank position sensor 64 and the intake cam position sensor 65. The absolute crank angle CA is set to 0° crank angle at the compression top dead center of the reference cylinder, increases up to 720° crank angle according to the angle of rotation of the crankshaft, and is set to 0° crank angle again at this time.

The air-fuel ratio sensor 66 is placed in the exhaust manifold 41 or the exhaust pipe 42, at a position between the collecting portion 41b (exhaust collecting portion HK) of the exhaust manifold 41, and the upstream-side catalyst 43.

The air-fuel ratio sensor 66 is a limiting current type wide range air-fuel ratio sensor having a diffusion resistance layer, which is disclosed in, for example, Japanese Patent Application Publication No. 11-72473 (JP 11-72473 A), Japanese Patent Application Publication No. 2000-65782 (JP 2000-65782 A), and Japanese Patent Application Publication No. 2004-69547 (JP 2004-69547 A).

The air-fuel ratio sensor 66 includes a protective cover (not shown) in the form of a hollow cylindrical body made of metal, and an air-fuel ratio sensing portion (not shown) housed in the protective cover. A plurality of through-holes is formed in the protective cover. In operation, exhaust gas flowing in the exhaust passage passes through through-holes formed in a side wall of the protective cover, reaches the air-fuel ratio sensing portion, and then flows out of the protective cover through through-holes formed in a bottom of the protective cover. The air-fuel ratio sensing portion includes a solid electrolyte layer.

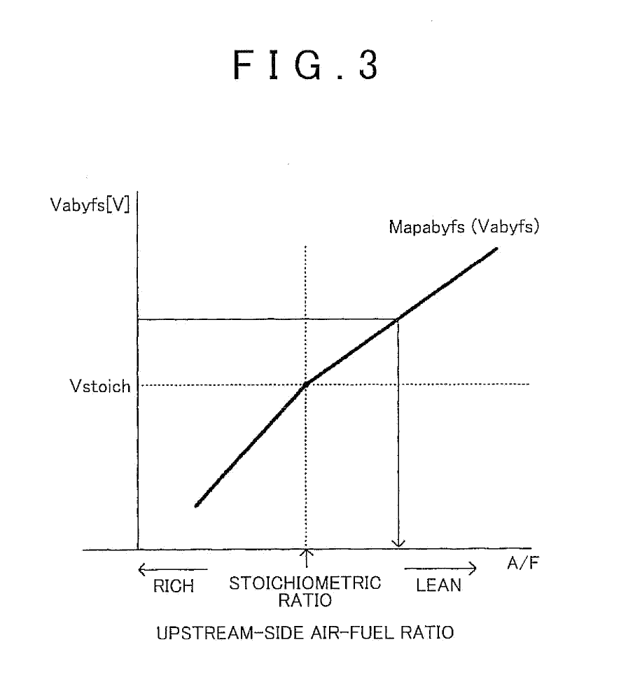

As shown in FIG. 3, the air-fuel ratio sensor 66 generates an output value Vabyfs that varies with the air-fuel ratio (detected air-fuel, ratio abyfs or upstream-side air-fuel ratio abyfs) of exhaust gas that reaches the air-fuel ratio sensor 66. The output value Vabyfs increases as the detected air-fuel ratio abyfs becomes leaner (the value of air-fuel ratio becomes larger). The electric control device 70 as described later converts the output value Vabyfs into the air-fuel ratio abyfs, using a table (air-fuel ratio conversion table Mapabyfs(Vabyfs)) as shown in FIG. 3. The air-fuel ratio resulting from the conversion is called “detected air-fuel ratio abyfs”.

The accelerator position sensor 67 as shown in FIG. 2 generates a signal indicative of the amount of operation Accp of the accelerator pedal AP operated by the driver (the accelerator pedal operation amount or the stroke of the accelerator pedal AP). The accelerator pedal operation amount Accp increases as the amount of operation of the accelerator pedal AP is (becomes) larger.

The electric control device 70 is a microcomputer that consists principally of CPU, ROM in which programs to be executed by the CPU, tables (maps, functions), constants, etc. are stored in advance, RAM into which the CPU temporarily stores data as needed, back-up RAM, and interfaces including AD converters, for example.

The electric control device 70 is connected to the above-described sensors, and so forth, and is configured to supply signals from these sensors, to the CPU. The electric control device 70 is also configured to send drive signals (command signals) to the ignition plug (not shown) (e.g., an igniter) provided for each cylinder, the fuel injection valve 33 provided for each cylinder, the throttle-valve actuator 35, and the EGR control valve 52, for example.

The electric control device 70 is configured to send a command signal to the throttle-valve actuator 35, so that the throttle opening TA increases as the obtained operation amount Accp of the accelerator pedal is larger. Namely, the electric control device 70 has a throttle valve driving means for changing the opening of the throttle valve 34 disposed in the intake passage of the engine 10, according to the accelerating operation amount (accelerator pedal operation amount Accp) of the engine 10, which is changed by the driver.

### (Operation of Determination System)

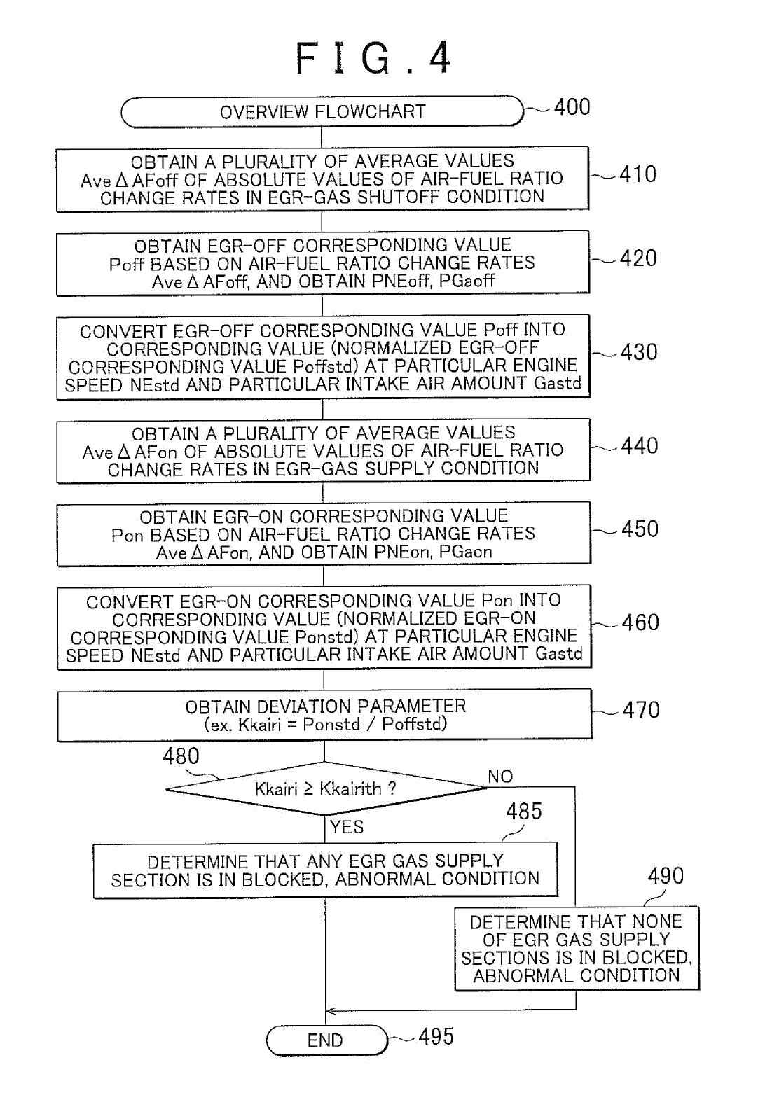

The summary of the operation of the determination system will be described with reference to an overview flowchart illustrated in FIG. 4. The determination system (the CPU of the electric control device 70) starts processing from step 400, executes step 410 through step 470 as described below, in the order of description, and then proceeds to step 480.

In step 410, the determination system obtains a plurality of air-fuel ratio change rates ΔAFoff under the EGR-gas shutoff condition, over a given period (in this embodiment, a period corresponding to 720° crank angle), each time a unit of time elapses. In the following description, the period corresponding to 720° crank angle is also called “unit combustion cycle period”. The unit combustion cycle period is defined as a period of time it takes for the crankshaft to rotate by a crank angle required for completion of one combustion stroke for each cylinder, in all of the cylinders from which exhaust gases that will reach the single air-fuel ratio sensor 66 are emitted.

The air-fuel ratio change rate ΔAFoff is an amount of change of the detected air-fuel ratio abyfs in a unit of time (sampling time, for example, 4 ms). The air-fuel ratio change rate ΔAFoff is obtained by subtracting the detected air-fuel ratio abyfs (=abyfsold) obtained the unit of time before the present time from the detected air-fuel ratio abyfs obtained at the present time in the EGR-gas shutoff condition. The air-fuel ratio change rate ΔAFoff corresponds to a time differential value (dabyfs/dt) of the detected air-fuel ratio abyfs in the EGR-gas shutoff condition. Accordingly, the air-fuel ratio change rate ΔAFoff may assume a positive value or a negative value. In this embodiment, the EGR-gas shutoff condition is established when the coolant temperature THW is lower than an EGR permissible temperature threshold THWegrth. The air-fuel ratio change rate ΔAFoff is one of basic data.

The determination system obtains an average value AveΔAFoff of a plurality of absolute values of air-fuel ratio change rates ΔAFoff obtained in one unit combustion cycle period. At this time, the determination system also obtains an average value AveNEoff of the engine speed NE and an average value AveGaoff of the intake air amount Ga in the unit combustion cycle period. The determination system obtains average values AveΔAFoff, average values AveNEoff of the engine speed NE, and average values AveGaoff of the intake air amount Ga, with respect to a plurality of unit combustion cycle periods.

In step 420, the determination system obtains an average value of a plurality of average values AveΔAFoff obtained with respect to the plurality of unit combustion cycle periods, as an EGR-OFF corresponding value Poff. The determination system also obtains an average value of a plurality of average values AveNEoff of the engine speed NE obtained with respect to the plurality of unit combustion cycle periods, as an EGR-OFF average engine speed PNEoff. Further, the determination system obtains an average value of a plurality of average values AveGaoff of the intake air amount Ga obtained with respect to the plurality of unit combustion cycle periods, as an EGR-OFF average intake air amount PGaoff.

The EGR-OFF average engine speed PNEoff corresponds to the engine speed in a period (i.e., first period) in which basic data (air-fuel ratio change rates ΔAFoff) that provides the obtained EGR-OFF corresponding value Poff is obtained. The EGR-OFF average intake air amount PGaoff corresponds to the intake air amount in the first period.

The determination system may obtain the average value AveΔAFoff obtained with respect to one unit combustion cycle period, as the EGR-OFF corresponding value Poff. In this case, the EGR-OFF average engine speed PNEoff is the average value AveNEoff of the engine speed NE in the above-indicated unit combustion cycle period, and the EGR-OFF average intake air amount PGaoff is the average value AveGaoff of the intake air amount Ga in the unit combustion cycle period.

In step 430, the determination system stores relationships (which will also be called “first conversion relationships”) among the EGR-OFF corresponding value Poff, EGR-OFF average engine speed PNEoff, EGR-OFF average intake air amount PGaoff, and normalized EGR-OFF corresponding value Poffstd, in the form of a lock-up table (map), in the ROM. The determination system applies the actual EGR-OFF corresponding value Poff, EGR-OFF average engine speed PNEoff, and the EGR-OFF average intake air amount PGaoff obtained in step 420, to the first conversion relationships (table), so as to obtain the actual normalized EGR-OFF corresponding value Poffstd.

The normalized EGR-OFF corresponding value Poffstd is an EGR-OFF corresponding value in the case where the EGR-OFF corresponding value Poff obtained in step 420 is assumed to be obtained at a particular engine speed NEstd, with a particular intake air amount Gastd. Namely, since the EGR-OFF corresponding value Poff varies under the influences of the engine speed NE and the intake air amount Ga, there is a need to remove or eliminate the influences of the engine speed NE and the intake air amount Ga. To meet this need, the determination system converts the EGR-OFF corresponding value Poff into a normalized EGR-OFF corresponding value Poffstd. This conversion is also called normalization (or dimensionless process) of the EGR-OFF corresponding value Poff.

In step 440, the determination system obtains a plurality of air-fuel ratio change rates ΔAFon under the EGR-gas supply condition, over a given period (in this embodiment, the unit combustion cycle period), each time a unit of time elapses. Like the air-fuel ratio change rate ΔAFoff, the air-fuel ratio change rate ΔAFon is obtained by subtracting the detected air-fuel ratio abyfs (=abyfsold) obtained the unit of time before the present time from the detected air-fuel ratio abyfs obtained at the present time in the EGR-gas supply condition. Accordingly, the air-fuel ratio change rate ΔAFon may assume a positive value or a negative value. In this embodiment, the EGR-gas supply condition is established when the coolant temperature THW is equal to or higher than the EGR permissible temperature threshold THWegrth. The air-fuel ratio change rate ΔAFon is one of the basic data.

The determination system obtains an average value AveΔAFon of a plurality of absolute values of air-fuel ratio change rates ΔAFon obtained in one unit combustion cycle period. At this time, the determination system also obtains an average value AveNEon of the engine speed NE and an average value AveGaon of the intake air amount Ga in the unit combustion cycle period. The determination system obtains average values AveΔAFon, average values AveNEon of the engine speed NE, and average values AveGaon of the intake air amount Ga, with respect to a plurality of unit combustion cycle periods.

In step 450, the determination system obtains an average value of a plurality of average values AveΔAFon obtained with respect to the plurality of unit combustion cycle periods, as an EGR-ON corresponding value Pon. The determination system also obtains an average value of a plurality of average values AveNEon of the engine speed NE obtained with respect to the plurality of unit combustion cycle periods, as an EGR-ON average engine speed PNEon. Further, the determination system obtains an average value of a plurality of average values AveGaon of the intake air amount Ga obtained with respect to the plurality of unit combustion cycle periods, as an EGR-ON average intake air amount PGaon.

The EGR-ON average engine speed PNEoff corresponds to the engine speed in a period (i.e., second period) in which basic data (air-fuel ratio change rates ΔAFon) that provide the obtained EGR-ON corresponding value Pon is obtained. The EGR-ON average intake air amount PGaon corresponds to the intake air amount in the second period.

The determination system may obtain the average value AveΔAFon obtained with respect to one unit combustion cycle period, as the EGR-ON corresponding value Pon. In this case, the EGR-ON average engine speed PNEon is the average value AveNEon of the engine speed NE in the above-indicated unit combustion cycle period, and the EGR-ON average intake air amount PGaon is the average value AveGaon of the intake air amount Ga in the unit combustion cycle period.

In step 460, the determination system stores relationships (which will also be called “second conversion relationships”) among the EGR-ON corresponding value Pon, EGR-ON average engine speed PNEon, EGR-ON average intake air amount PGaon, and normalized EGR-ON corresponding value Ponstd, in the form of a lock-up table (map), in the ROM. The determination system applies the actual EGR-ON corresponding value Pon, EGR-ON average engine speed PNEon, and the EGR-ON average intake air amount PGaon obtained in step 450, to the second conversion relationships (table), so as to obtain the actual normalized EGR-ON corresponding value Ponstd.

The normalized EGR-ON corresponding value Ponstd is an EGR-ON corresponding value in the case where the EGR-ON corresponding value Pon obtained in step 450 is assumed to be obtained at a particular engine speed NEstd, with a particular intake air amount Gastd. Namely, since the EGR-ON corresponding value Pon varies under the influences of the engine speed NE and the intake air amount Ga, like the EGR-OFF corresponding value Poff, there is a need to remove or eliminate the influences of the engine speed NE and the intake air amount Ga. To meet this need, the determination system converts the EGR-ON corresponding value Pon into a normalized EGR-ON corresponding value Ponstd. This conversion is also called normalization (or dimensionless process) of the EGR-ON corresponding value Pon.

The determination system then proceeds to step 470, to calculate a deviation parameter Kkairi by dividing the normalized EGR-ON corresponding value Ponstd by the normalized EGR-OFF corresponding value Poffstd, as indicated in Eq. (1) below. Namely, the deviation parameter Kkairi is the ratio of Ponstd to Poffstd.

Kkairi=Ponstd/Poffstd (1)

The deviation parameter Kkairi, which is also called “deviation evaluation value”, is a value used for evaluating the relationship in magnitude between the normalized EGR-OFF corresponding value Poffstd and the normalized EGR-ON corresponding value Ponstd. In other words, the deviation parameter Kkairi represents a degree of deviation between the normalized EGR-OFF corresponding value Poffstd and the normalized EGR-ON corresponding value Ponstd.

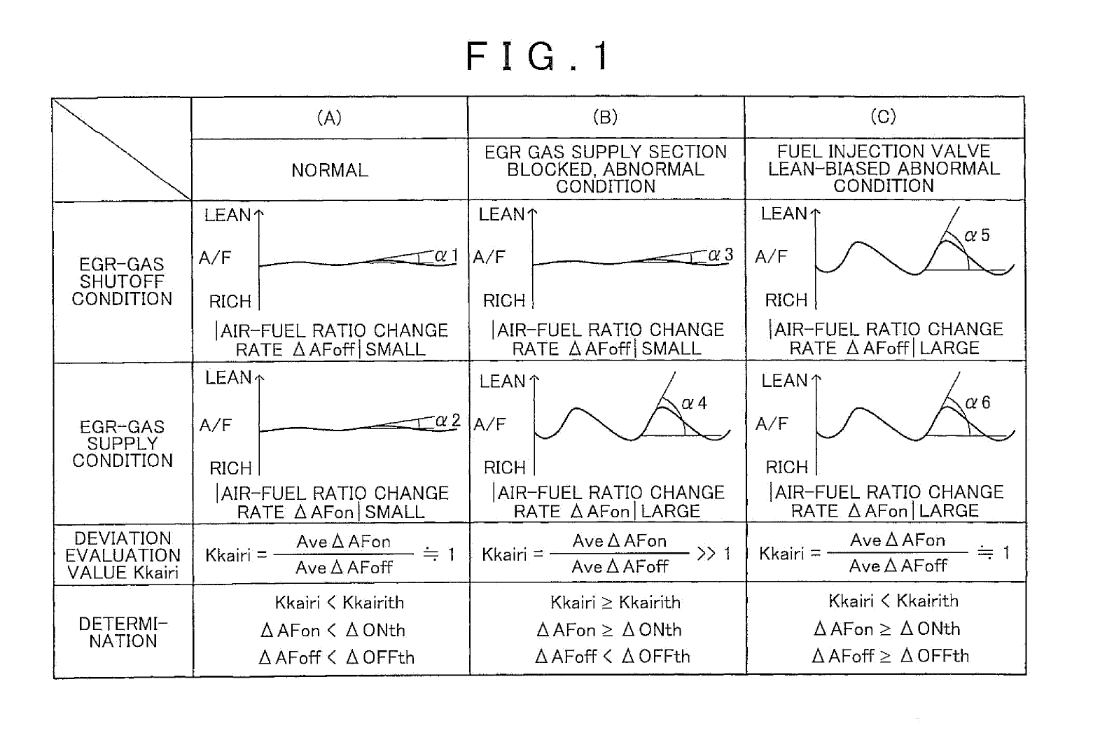

The determination system proceeds to step 480, to determine whether the deviation parameter Kkairi is equal to or larger than a threshold deviation Kkairith. The threshold deviation Kkairith is set to a value obtained by adding a (very small) given value (margin β) to “1”. As explained above with reference to FIG. 1, when any of the EGR gas supply sections is in a blocked, abnormal condition, the deviation parameter Kkairi becomes equal to a far larger value than “1”, and thus becomes equal to or larger than the threshold deviation Kkairith.

When the deviation parameter Kkairi is equal to or larger than the threshold deviation Kkairith, the determination system makes an affirmative decision (YES) in step 480, and proceeds to step 485. In step 485, the determination system determines that any of the EGR gas supply sections is in a blocked, abnormal condition. Then, the determination system proceeds to step 495, and completes the processing.

On the other hand, when the deviation parameter Kkairi is smaller than the threshold deviation Kkairith, the determination system makes a negative decision (NO) in step 480, and proceeds to step 490. In step 490, the determination system determines that none of the EGR gas supply sections is in a blocked, abnormal condition. Then, the determination system proceeds to step 495, and completes the processing.

### First Modified Example

In step 410 of FIG. 4, the determination system may select air-fuel ratio change rates ΔAFoff having positive values, from the plurality of air-fuel ratio change rates ΔAFoff obtained in one unit combustion cycle period, and may employ an average value of the selected air-fuel ratio change rates (ΔAFoff) having positive values, as the average value AveΔAFoff. In this case, in step 440 of FIG. 4, too, the determination system may select air-fuel ratio change rates ΔAFon having positive values, from the plurality of air-fuel ratio change rates ΔAFon obtained in one unit combustion cycle period, and may employ an average value of the selected air-fuel ratio change rates (ΔAFon) having positive values, as the average value AveΔAFon.

In this case, when the determination system proceeds to step 490 of FIG. 4, it may determine that a lean imbalance condition caused by a fuel injection valve of a particular cylinder is created if the normalized EGR-OFF corresponding value Poffstd is equal to or larger than a threshold value ΔOFFth, or the normalized EGR-ON corresponding value Ponstd is equal to or larger than a threshold value ΔONth. If the normalized EGR-OFF corresponding value Poffstd is smaller than the threshold value ΔOFFth, and the normalized EGR-ON corresponding value Ponstd is smaller than the threshold value ΔONth, the determination system may determine that the fuel injection valves and the EGR supply device are in normal conditions (or no lean imbalance condition caused by a fuel injection valve of a particular cylinder is created, and none of the EGR gas supply sections is in a blocked, abnormal condition). The lean imbalance condition caused by the fuel injection valve of the particular cylinder, which is also called “lean-biased abnormal condition of the fuel injection valve”, is a condition in which one of the fuel injection valves 33 provided for the respective cylinders is caused to inject a smaller amount of fuel than the specified fuel injection amount.

### Second Modified Example

In step 410 of FIG. 4, the determination system may obtain the amount of change in the output value Vabyfs of the air-fuel ratio sensor 66, in a unit of time (sampling time, e.g., 4 ms), as the air-fuel ratio change rate ΔAFoff. In this case, in step 440 of FIG. 4, the determination system obtains the amount of change in the output value Vabyfs of the air-fuel ratio sensor 66, in a unit of time (sampling time, e.g., 4 ms), as the air-fuel ratio change rate ΔAFon.

### (Actual Operation)

The actual operation of the determination system will be described.

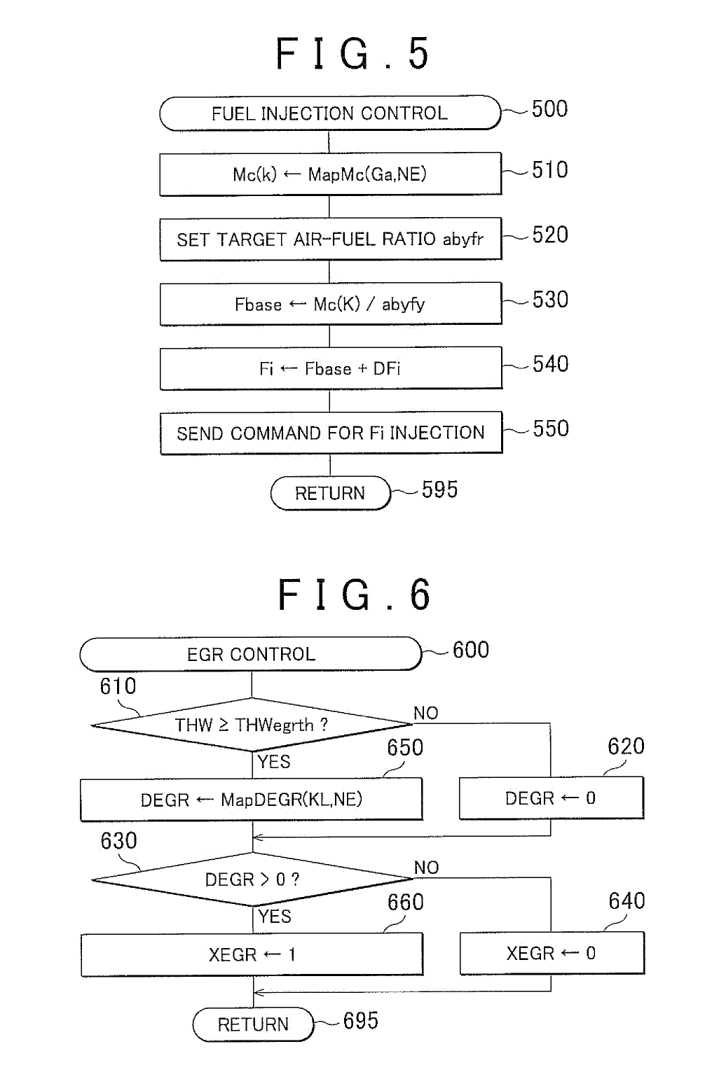

The CPU repeatedly executes a routine for controlling the fuel injection amount, as illustrated in FIG. 5, with respect to a certain cylinder (which will be called “fuel injection cylinder”), each time the crank angle of the cylinder becomes equal to a given crank angle (e.g., BTDC 90° CA) before the top dead center of the intake stroke. The CPU start processing from step 500 at the right time, executes step 510 through step 550 as described below, in the order of description, and proceeds to step 595 to once finish the routine.

In step 510, the CPU obtains an in-cylinder intake air amount Mc(k) as an amount of air drawn by suction into the fuel injection cylinder, based on the intake air flow rate Ga measured by the air flow meter 61, the engine speed NE obtained based on a signal of the crank position sensor 64, and a look-up table MapMc.

In step 520, the CPU sets an upstream-side target air-fuel ratio abyfr according to operating conditions of the engine 10. In the determination system of this embodiment, the upstream-side target air-fuel ratio abyfr is set to the stoichiometric air-fuel ratio stoich except in special cases.

In step 530, the CPU obtains a basic fuel injection amount Fbase by dividing the in-cylinder intake air amount Mc(k) by the upstream-side target air-fuel ratio abyfr.

In step 540, the CPU calculates a specified fuel injection amount (final fuel injection amount) Fi by adding a main feedback amount DFi to the basic fuel injection amount Fbase. The feedback amount DFi is reduced when the detected air-fuel ratio abyfs is smaller (richer) than the upstream-side target air-fuel ratio abyfr, and is increased when the detected air-fuel ratio abyfs is larger (leaner) than the upstream-side target air-fuel ratio abyfr.

In step 550, the CPU sends an injection command signal to the fuel injection valve 33, so that the fuel is injected in the specified fuel injection amount Fi from the fuel injection valve 33 corresponding to the fuel injection cylinder.

### <EGR Control>

The processing for performing EGR control will be described. The CPU executes an EGR control routine as illustrated in the flowchart of FIG. 6 at given time intervals.

The CPU starts processing from step 600 at the right time, and proceeds to step 610. In step 610, the CPU determines whether the coolant temperature THW is equal to or higher than a threshold value THWegrth of the EGR permissible temperature, so as to determine whether an EGR permission condition (a condition under which EGR is permitted) is satisfied. The EGR permission condition may be another condition or conditions, such as a condition that the load KL is equal to or greater than a given value, and/or a condition that the rate of change of the load KL is equal to or smaller than a given rate of change.

If the coolant temperature THW is not equal to nor higher than the threshold value THWegrth of the EGR permissible temperature, the CPU makes a negative decision (NO) in step 610, and proceeds to step 620 to set the duty ratio DEGR to 0. As a result, the EGR control valve 52 is fully closed, and no EGR gas (external EGR gas) is supplied to the engine 10 (combustion chamber 21). Namely, an EGR-gas shutoff condition is established.

The CPU then proceeds to step 630 to determine whether the duty ratio DEGR is larger than “0”. In this case, the duty ratio DEGR is 0; therefore, the CPU makes a negative decision (NO) in step 630, and proceeds to step 640 to set a value of an EGR supply flag XEGR to 0. Then, the CPU proceeds to step 695 to once finish the routine of FIG. 6.

If the coolant temperature THW is equal to or higher than the threshold value THWegrth of the EGR permissible temperature at the time when the CPU executes step 610, the CPU makes an affirmative decision (YES) in, step 610, and proceeds to step 650. In step 650, the CPU applies the load KL and the engine speed NE measured at the time when the above step 610 is executed, to a table MapDEGR(KL, NE), so as to determine the duty ratio DEGR. Namely, the CPU calculates the duty ratio DEGR based on the load KL and the engine speed NE, and sends a command signal based on the duty ratio DEGR, to the EGR control valve 52. As a result, if the duty ratio DEGR obtained according to the table MapDEGR(KL, NE) is not equal to 0, the EGR control valve 52 is opened according to the duty ratio DEGR, and the EGR gas is supplied to the combustion chamber 21 of each cylinder, through each EGR gas supply port 51b, so that an EGR-gas supply condition is established.

The CPU then proceeds to step 630 to determine whether the duty ratio DEGR is equal to or larger than 0. If the duty ratio DEGR is larger than 0, the CPU makes an affirmative decision (YES) in step 630, and proceeds to step 660 to set the value of the EGR supply flag XEGR to 1. Accordingly, the EGR supply flag XEGR indicates that the EGR-gas supply condition is established when its value is 1, and indicates that the EGR-gas shutoff condition is established when its value is 0. Then, the CPU proceeds to step 695 to once finish the routine of FIG. 6.

### <Acquisition of Normalized EGR-OFF Corresponding Value>

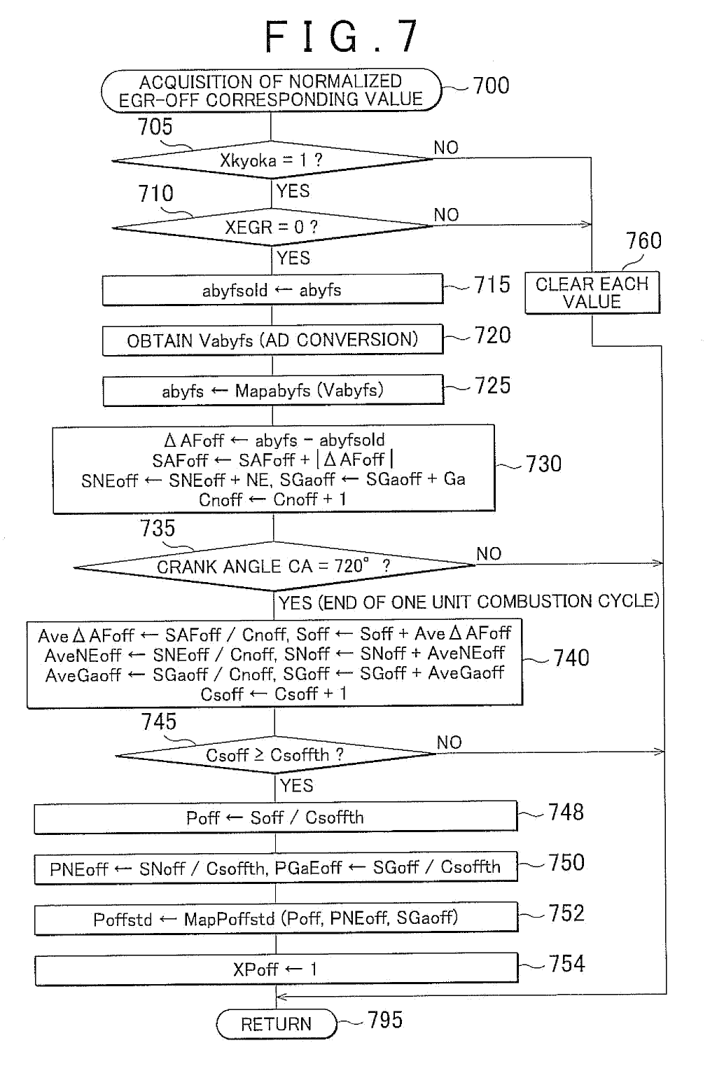

The processing for acquiring a normalized EGR-OFF corresponding value will be described. The CPU executes a routine as illustrated in the flowchart of FIG. 7, each time 4 ms (4 milliseconds=given sampling time ts) elapses.

The CPU starts processing from step 700 at the right time, and proceeds to step 705 to determine whether a value of a parameter acquisition permission flag Xkyoka is 1.

The parameter acquisition permission flag Xkyoka is set to 0 in the initial routine. By executing a routine (not shown), the parameter acquisition permission flag Xkyoka is set to 1 when a parameter acquisition condition is satisfied, namely, when all of the below-listed acquisition permission conditions are satisfied, at the time when a reference cylinder (the first cylinder in this embodiment) reaches the top dead center of the compression stroke. The parameter acquisition permission flag Xkyoka is immediately set to 0 when the parameter acquisition condition is not satisfied. The acquisition permission conditions are not limited to the conditions as described below.

Acquisition permission condition 1 is that the amount of change ΔAccp of the accelerator pedal operation amount Accp per unit time is kept equal to or smaller than a threshold accelerator pedal change amount ΔAccpth for a given period of time or longer.

Acquisition permission condition 2 is that the intake air flow rate Ga is kept equal to or larger than a threshold intake air flow rate Gath for a given period of time or longer.

Acquisition permission condition 3 is that the engine speed NE is kept equal to or lower than a threshold engine speed NEth for a given period of time or longer.

When the value of the parameter acquisition permission flag Xkyoka is assumed to be 1, the CPU makes an affirmative decision (YES) in step 705, and proceeds to step 710 to determine whether the value of the EGR supply flag XEGR is 0.

If the value of the EGR supply flag XEGR is 0, the CPU makes an affirmative decision (YES) in step 710, executes step 715 through step 730 as described below, in the order of description, and proceeds to step 735.

In step 715, the CPU stores the detected air-fuel ratio abyfs obtained when this routine was executed last time (i.e., in the last cycle of this routine), as the last detected air-fuel ratio abyfsold.

In step 720, the CPU obtains an output value Vabyfs of the air-fuel ratio sensor 66 at this time, through AD conversion.

In step 725, the CPU applies the output value Vabyfs of the air-fuel ratio sensor 66 to the air-fuel ratio conversion table Mapabyfs(Vabyfs) shown in FIG. 3, so as to obtain the detected air-fuel ratio abyfs of this cycle.

In step 730, the CPU updates the air-fuel ratio change rate ΔAFoff in the EGR-gas shutoff condition, integrated value SAFoff as a sum of the absolute values of the air-fuel ratio change rates ΔAFoff, integrated value SNEoff of the engine speed NE, integrated value SGaoff of the intake air amount Ga, and a value of a counter Cnoff that counts the number of times of integration, according to expressions indicated in step 730.

The CPU proceeds to step 735 to determine whether the crank angle CA (absolute crank angle CA) relative to the top dead center of the compression stroke of the first cylinder is equal to 720° crank angle. If the absolute crank angle CA is smaller than 720° crank angle, the CPU makes a negative decision (NO) in step 735, and directly proceeds to step 795, to once finish the routine of FIG. 7.

If the absolute crank angle CA is equal to 720° crank angle at the time when the CPU executes step 735, the CPU makes an affirmative decision (YES) in step 735, and proceeds to step 740. In step 740, the CPU updates the average value AveΔAFoff of the absolute values |ΔAFoff| of the air-fuel ratio change rates ΔAFoff, integrated value Soff of the average value AveΔAFoff, average value AveNEoff of the engine speed NE, integrated value SNoff of the average value AveNEoff of the engine speed NE, average value AveGaoff of the intake air amount Ga, integrated value SGoff of the average value AveGaoff of the intake air amount Ga, and a value of a counter Csoff that counts the number of times of integration, according to expressions indicated in step 740.

The CPU then proceeds to step 745 to determine whether the value of the counter Csoff is equal to or larger than a threshold value Csoffth. If the value of the counter Csoff is smaller than the threshold value Csoffth, the CPU makes a negative decision (NO) in step 745, and directly proceeds to step 795 to once finish the routine of FIG. 7. The threshold value Csoffth is a natural number, which is desirably 2 or larger.

If the value of the counter Csoff is equal to or larger than the threshold value Csoffth at the time when the CPU executes step 745, the CPU makes an affirmative decision (YES) in step 745, executes step 748 through step 754 as described below, in the order of description, and then proceeds to step 795 to once finish the routine of FIG. 7.

In step 748, the CPU calculates the EGR-OFF corresponding value Poff according to an expression indicated in step 748.

In step 750, the CPU calculates the EGR-OFF engine speed (average value) PNEoff and the EGR-OFF intake air amount (average value) PGaoff, according to expressions indicated in step 750.

In step 752, the CPU applies Poff, PNEoff and PGaoff obtained in step 748 and step 750, to a table MapPoffstd (Poff, PNEoff, PGaoff that defines the first conversion relationships as described above, so as to calculate the normalized EGR-OFF corresponding value Poffstd.

In step 754, the CPU sets a value of an EGR-OFF corresponding value acquisition completion flag XPoff to 1. The initial value of the flag XPoff is 0.

If the value of the parameter acquisition permission flag Xkyoka is not 1 when the CPU proceeds to step 705, and if the value of the EGR supply flag XEGR is not 0 when the CPU proceeds to step 710, the CPU proceeds to step 760. In step 760, the CPU sets (clears) respective values (e.g., ΔAFoff, SAFoff, SNEoff, SGaoff, Cnoff, etc.) to 0, and directly proceeds to step 795 to once finish the routine of FIG. 7. In the above manner, the normalized EGR-OFF corresponding value Poff is obtained.

### <Acquisition of Normalized EGR-ON Corresponding Value>

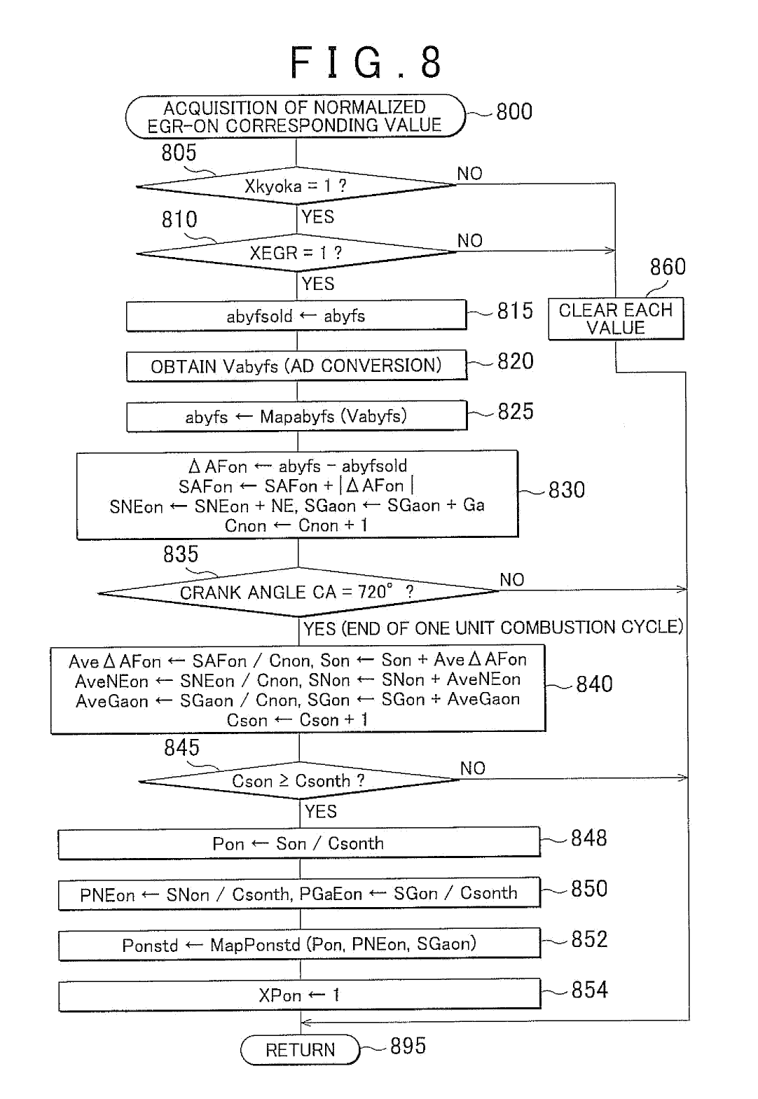

The processing for acquiring a normalized EGR-ON corresponding value will be described. The CPU executes a routine as illustrated in the flowchart of FIG. 8 each time 4 ms (4 milliseconds=given sampling time ts) elapses.

The CPU starts processing from step 800 at the right time, and proceeds to step 805 to determine whether the value of the parameter acquisition permission flag Xkyoka is 1.

When the value of the parameter acquisition permission flag Xkyoka is assumed to be 1, the CPU makes an affirmative decision (YES) in step 805, and proceeds to step 810 to determine whether the value of the EGR supply flag XEGR is 1.

If the value of the EGR supply flag XEGR is 1, the CPU makes an affirmative decision (YES) in step 810, executes step 815 through step 830 as described below, in the order of description, and proceeds to step 835. The operations of step 815 through step 825 are identical with those of step 715 through step 725 of FIG. 7, and thus will not be described.

In step 830, the CPU updates the air-fuel ratio change rate ΔAFon in the EGR-gas supply condition, integrated value SAFon as a sum of absolute values of the air-fuel ratio change rates ΔAFon, integrated value SNEon of the engine speed NE, integrated value SGaon of the intake air amount Ga, and a value of a counter Cnon that counts the number of times of integration, according to expressions indicated in step 830.

The CPU proceeds to step 835 to determine whether the absolute crank angle CA is equal to 720° crank angle. If the absolute crank angle CA is smaller than 720° crank angle, the CPU makes a negative decision (NO) in step 835, and directly proceeds to step 895, to once finish the routine of FIG. 8.

If the absolute crank angle CA is equal to 720° crank angle at the time when the CPU executes step 835, the CPU makes an affirmative decision (YES) in step 835, and proceeds to step 840. In step 840, the CPU updates the average value AveΔAFon of the absolute values |ΔAFon| of the air-fuel ratio change rates ΔAFon, integrated value Son of the average value AveΔAFon, average value AveNEon of the engine speed NE, integrated value SNon of the average value AveNEon of the engine speed NE, average value AveGaon of the intake air amount Ga, integrated value SGon of the average value AveGaon of the intake air amount Ga, and a value of a counter Cson that counts the number of times of integration, according to expressions indicated in step 840.

The CPU then proceeds to step 845 to determine whether the value of the counter Cson is equal to or larger than a threshold value Csonth. If the value of the counter Cson is smaller than the threshold value Csonth, the CPU makes a negative decision (NO) in step 845, and directly proceeds to step 895 to one finish the routine of FIG. 8. The threshold value CSonth is a natural number, which is desirably 2 or larger.

If the value of the counter Cson is equal to or larger than the threshold value Csonth at the time when the CPU executes step 845, the CPU makes an affirmative decision (YES) in step 845, executes step 848 through step 854 as described below, in the order of description, and then proceeds to step 895 to once finish the routine of FIG. 8.

In step 848, the CPU calculates the EGR-ON corresponding value Pon according to an expression indicated in step 848.

In step 850, the CPU calculates the EGR-ON engine speed (average value) PNEon and the EGR-ON intake air amount (average value) PGaon, according to expressions indicated in step 850.

In step 852, the CPU applies Pon, PNEon and PGaon obtained in step 848 and step 850, to a table MapPonstd (Pon, PNEon, PGaon) that defines the second conversion relationships as described above, so as to calculate the normalized EGR-ON corresponding value Ponstd.

In step 854, the CPU sets a value of an EGR-ON corresponding value acquisition completion flag XPon to 1. The initial value of the flag XPon is 0.

If the value of the parameter acquisition permission flag Xkyoka is not 1 when the CPU proceeds to step 805, and if the value of the EGR supply flag XEGR is not 1 when the CPU proceeds to step 810, the CPU proceeds to step 860. In step 860, the CPU sets (clears) respective values (e.g., ΔAFon, SAFon, SNEon, SGaon, Cnon, etc.) to 0, and directly proceeds to step 895 to once finish the routine of FIG. 8. In the above manner, the normalized EGR-ON corresponding value Pon is obtained.

### <Abnormality Determination>

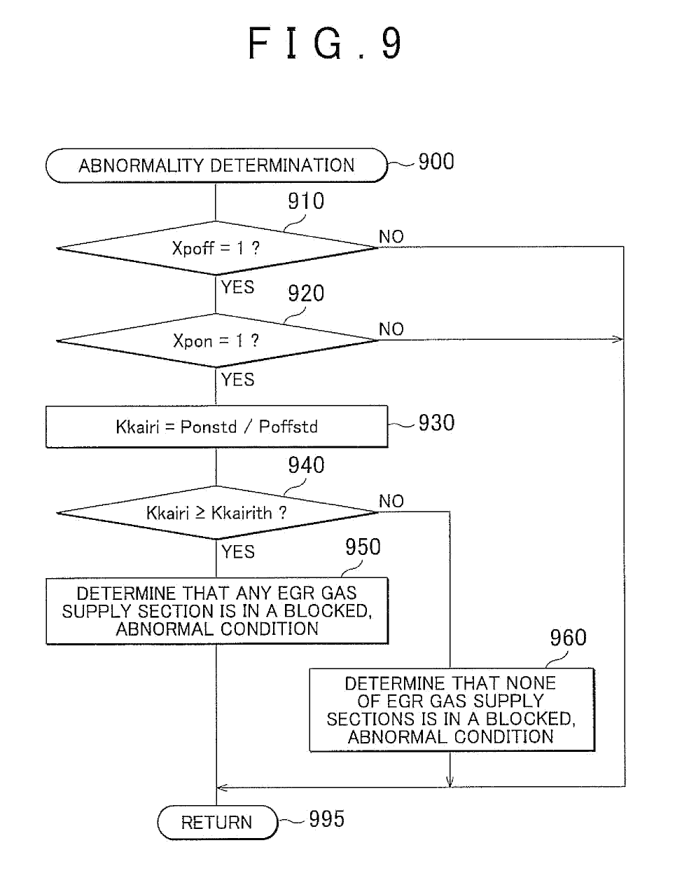

The processing for making an abnormality determination will be described. The CPU executes a routine as illustrated in the flowchart of FIG. 9 at given time intervals. The CPU starts processing from step 900 at the right time, and proceeds to step 910 to determine whether the value of the EGR-OFF corresponding value acquisition completion flag XPoff is 1. If the value of the EGR-OFF corresponding value acquisition completion flag XPoff is not 1, the CPU makes a negative decision (NO) in step 910, and directly proceeds to step 995 to once finish the routine of FIG. 9.

If the value of the EGR-OFF corresponding value acquisition completion flag XPoff is “1”, the CPU makes an affirmative decision (YES) in step 910, and proceeds to step 920 to determine whether the EGR-ON corresponding value acquisition completion flag XPon is “1”. If the value of the EGR-ON corresponding value acquisition completion flag XPon is not 1, the CPU makes a negative decision (NO) in step 920, and directly proceeds to step 995 to once finish the routine of FIG. 9.

If the value of the EGR-ON corresponding value acquisition completion flag Pon is “1”, the CPU makes an affirmative decision (YES) in step 920, and proceeds to step 930 to calculate the above-mentioned deviation parameter Kkairi. The CPU then proceeds to step 940 to determine whether the deviation parameter Kkairi is equal to or larger than the threshold deviation Kkairith.

If the deviation parameter Kkairi is equal to or larger than the threshold deviation Kkairith, the CPU makes an affirmative decision (YES) in step 940, and proceeds to step 950 to determine that any of the EGR gas supply sections is in a blocked, abnormal condition. Then, the determination system proceeds to step 995 to finish the processing. On the other hand, if the deviation parameter Kkairi is smaller than the threshold deviation Kkairith, the determination system makes a negative decision (NO) in step 940, and proceeds to step 960 to determine that none of the EGR-gas supply sections is in a blocked, abnormal condition. Then, the determination system proceeds to step 995 to finish the processing.

As explained above, the abnormality determination system for the internal combustion engine according to this embodiment of the invention includes an EGR gas supplying means (51, 52), EGR gas supply control means (see the routine of FIG. 6), and the air-fuel ratio sensor (66).

The abnormality determination system obtains the amount of change in the output value of the air-fuel ratio sensor or the detected air-fuel ratio represented by the output value of the air-fuel ratio sensor per unit time, as basic data (see step 410 and step 440 of FIG. 4, step 715 through step 725 of FIG. 7, and step 815 through step 825 of FIG. 8). The abnormality determination system further includes a change rate corresponding value acquiring means (see step 420 and step 450 of FIG. 4, step 748 of FIG. 7, and step 848 of FIG. 8) for acquiring change rate corresponding values (Poff, Pon) that vary according to the basic data, based on the basic data, and an abnormality determining means (see step 480 through step 490 of FIG. 4, and the routine of FIG. 9) for making an abnormality determination as to whether one of the plurality of EGR gas supply sections is in an abnormal condition in which the EGR gas supply section is blocked or clogged, based on the EGR-OFF corresponding value (Poff) that is the change rate corresponding value obtained when the EGR gas shutoff condition is established, and the EGR-ON corresponding value (Pon) that is the change rate corresponding value obtained when the EGR gas supply condition is established.

The abnormality determining means obtains the normalized EGR-OFF corresponding value (Poffstd), by converting the obtained EGR-OFF corresponding value (Puff) into an EGR-OFF corresponding value that would be obtained when the rotational speed (PNEoff) of the engine in the first period in which the basic data of the EGR-OFF corresponding value was obtained is equal to a particular engine speed, and the intake air amount (PGaoff) of the engine in the first period is equal to a particular intake air amount (see step 430 of FIG. 4, and step 752, in particular, of FIG. 7). In addition to the acquisition of the normalized EGR-OFF corresponding value, the abnormality determining means obtains the normalized EGR-ON corresponding value (Ponstd), by converting the obtained EGR-ON corresponding value (Pon) into an EGR-ON corresponding value that would be obtained when the rotational speed (PNEon) of the engine in the second period in which the basic data of the EGR-ON corresponding value was obtained is equal to a particular engine speed, and the intake air amount (PGaon) of the engine in the second period is equal to a particular intake air amount (see step 460 of FIG. 4, and step 852, in particular, of FIG. 8). In addition, the abnormality determining means is configured to make the abnormality determination, by evaluating the relationship in magnitude between the normalized EGR-OFF corresponding value (Poffstd) and the normalized EGR-ON corresponding value (Ponstd) (see step 470 through step 490 of FIG. 4, and step 940 through step 960, in particular, of FIG. 9).

Accordingly, even in the case where the engine speed and intake air amount measured in the period (first period) in which data (i.e., basic data) that provides a basis for calculation of the EGR-OFF corresponding value (Poff) were obtained are respectively different from the engine speed and intake air amount measured in the period (second period) in which data (i.e., basic data) that provides a basis for calculation of the EGR-ON corresponding value (Pon) were obtained, the determination system can accurately determine whether any of the EGR gas supply sections is in a blocked, abnormal condition. Further, an operating region in which the EGR-OFF corresponding value and the EGR-ON corresponding value are obtained need not be limited to a narrow range; therefore, the determination system is able to determine, without significant delay, whether any of the EGR gas supply sections is in a blocked, abnormal condition.

The invention is not limited to the illustrated embodiment, but various modified examples may be employed within the scope of the invention. For example, in step 752 of FIG. 7, the actual Poff, PNEoff and PGaoff are applied to the table MapPoffstd (Poff, PNEoff, PGaoff) that defines the first conversion relationships, so that the normalized EGR-OFF corresponding value Poffstd is calculated. Rather, in step 752 of FIG. 7, a correction coefficient Koff may be obtained by applying the actual Poff, PNEoff and PGaoff to a table MapKoffstd (Poff, PNEoff, PGaoff), and the normalized EGR-OFF corresponding value Poffstd may be calculated by multiplying the actual EGR-OFF corresponding value Poff by the correction coefficient Koff. In this case, too, it may be said that the normalized EGR-OFF corresponding value Poffstd is obtained using the first conversion relationships.

Similarly, in step 852 of FIG. 8, the actual Pon, PNEon and PGaon are applied to the table MapPonstd (Pon, PNEon, PGaon) that defines the second conversion relationships, so that the normalized EGR-ON corresponding value Ponstd is calculated. Rather, in step 852 of FIG. 8, a correction coefficient Kon may be obtained by applying the actual Pon, PNEon and PGaon to a table MapKonstd (Pon, PNEon, PGaon), and the normalized EGR-ON corresponding value Ponstd may be calculated by multiplying the actual EGR-ON corresponding value Pon by the correction coefficient Kon. In this case, too, it may be said that the normalized EGR-ON corresponding value Ponstd is obtained using the second conversion relationships.

The EGR rate may be added as an argument of the table MapPonstd or MapKonstd that defines the second conversion relationships. The EGR rate may be obtained from Ga and the duty ratio DEGR.

The ratio of Poffstd to Ponstd (=Poffstd/Ponstd) may be used as a deviation parameter Kkairi. In this case, when the deviation parameter Kkairi is equal to or smaller than a given value smaller than 1, the determination system determines that any of the EGR gas supply sections is in a blocked, abnormal condition. As a deviation parameter Kkairi, value Ponstd/(Ponstd+Poffstd) may be used, or the reciprocal thereof may be used. Also, a difference (=Ponstd−Poffstd) between Ponstd and Poffstd may be used as a deviation parameter Kkairi. In this case, the determination system determines that any of the EGR gas supply sections is in a blocked, abnormal condition when the difference (=Ponstd−Poffstd) is equal to or larger than a given threshold value.

The internal combustion engine 10 may be installed on a hybrid vehicle that runs with torque produced by at least one of the engine 10 and the electric motor and transmitted to the drive shaft connected to the driving wheels of the vehicle.

What is claimed is:

1. An abnormality determination system for an internal combustion engine, comprising:
a plurality of EGR gas supply sections provided for at least two cylinders, respectively, of a plurality of cylinders included in a multi-cylinder internal combustion engine, said plurality of cylinders being arranged to emit exhaust gas into one exhaust collecting portion of an exhaust passage of the engine, said plurality of EGR gas supply sections being arranged to supply external EGR gas to respective combustion chambers of said at least two cylinders;
an EGR gas supply control unit that executes supply of the external EGR gas through said plurality of EGR gas supply sections when an operating condition of the engine satisfies a given EGR execution condition, and stops supply of the external EGR gas when the operating condition of the engine does not satisfy the given EGR execution condition;
an air-fuel ratio sensor placed in the exhaust collecting portion or a portion of the exhaust passage downstream of the exhaust collecting portion, said air-fuel ratio sensor being operable to generate an output value that varies with an air-fuel ratio of exhaust gas in the exhaust collecting portion or said portion of the exhaust passage; and
an abnormality determining unit that determines an abnormality in the internal combustion engine, wherein:
the abnormality determining unit obtains an amount of change in the output value of the air-fuel ratio sensor or a detected air-fuel ratio represented by the output value of the air-fuel ratio sensor per unit time, as basic data, and obtains a change rate corresponding value that varies according to the basic data, based on the basic data;
the abnormality determining unit obtains an EGR-OFF corresponding value during shutoff of the EGR gas, as the change rate corresponding value obtained while the EGR gas is shut off, and obtains an EGR-ON corresponding value during supply of the EGR gas, as the change rate corresponding value obtained while the EGR gas is supplied;
the abnormality determining unit obtains a normalized EGR-OFF corresponding value, by converting the obtained EGR-OFF corresponding value into an EGR-OFF corresponding value to be obtained when a rotational speed of the engine in a first period in which the basic data that provides the EGR-OFF corresponding value is obtained is equal to a particular engine speed, and an intake air amount of the engine in the first period is equal to a particular intake air amount;
the abnormality determining unit obtains a normalized EGR-ON corresponding value, by converting the obtained EGR-ON corresponding value into an EGR-ON corresponding value to be obtained when the rotational speed of the engine in a second period in which the basic data that provides the EGR-ON corresponding value is obtained is equal to the particular engine speed, and the intake air amount of the engine in the second period is equal to the particular intake air amount; and
the abnormality determining unit makes an abnormality determination as to whether any of said plurality of EGR gas supply sections is in an abnormal condition in which the EGR gas supply section is blocked, based on a relationship in magnitude between the normalized EGR-OFF corresponding value and the normalized EGR-ON corresponding value.

2. The abnormality determination system for the internal combustion engine according to claim 1, wherein:
the abnormality determining unit stores, in advance, first conversion relationships that define relationships among the EGR-OFF corresponding value, the engine speed in the first period, the intake air amount in the first period, and the normalized EGR-OFF corresponding value;
the abnormality determining unit is configured to obtain the normalized EGR-OFF corresponding value used for making the abnormality determination, based on an actual engine speed in the first period in which the EGR-OFF corresponding value is actually obtained, an actual intake air amount in the first period in which the EGR-OFF corresponding value is actually obtained, the actually obtained EGR-OFF corresponding value, and the first conversion relationships;
the abnormality determining unit stores, in advance, second conversion relationships that define relationships among the EGR-ON corresponding value, the engine speed in the second period, the intake air amount in the second period, and the normalized EGR-ON corresponding value; and
the abnormality determining unit is configured to obtain the normalized EGR-ON corresponding value used for making the abnormality determination, based on an actual engine speed in the second period in which the EGR-ON corresponding value is actually obtained, an actual intake air amount in the second period in which the EGR-ON corresponding value is actually obtained, the actually obtained EGR-ON corresponding value, and the second conversion relationships.

3. An abnormality determining method for an internal combustion engine including a plurality of cylinders, and a plurality of EGR gas supply sections that supply EGR gas to the respective cylinders, comprising:
obtaining an amount of change in an air-fuel ratio of exhaust gas emitted from the internal combustion engine per unit time, as basic data, and obtaining a change rate corresponding value that varies according to the basic data, based on the basic data;
obtaining an EGR-OFF corresponding value during shutoff of the EGR gas, as the change rate corresponding value obtained while the EGR gas is shut off, and obtaining an EGR-ON corresponding value during supply of the EGR gas, as the change rate corresponding value obtained while the EGR gas is supplied;
obtaining a normalized EGR-OFF corresponding value, by converting the obtained EGR-OFF corresponding value into an EGR-OFF corresponding value to be obtained when a rotational speed of the engine in a first period in which the basic data that provides the EGR-OFF corresponding value is obtained is equal to a particular engine speed, and an intake air amount of the engine in the first period is equal to a particular intake air amount;
obtaining a normalized EGR-ON corresponding value, by converting the obtained EGR-ON corresponding value into an EGR-ON corresponding value to be obtained when the rotational speed of the engine in a second period in which the basic data that provides the EGR-ON corresponding value is obtained is equal to the particular engine speed, and the intake air amount of the engine in the second period is equal to the particular intake air amount; and
making an abnormality determination as to whether any of said plurality of EGR gas supply sections is in an abnormal condition in which the EGR gas supply section is blocked, based on a relationship in magnitude between the normalized EGR-OFF corresponding value and the normalized EGR-ON corresponding value.

4. The abnormality determining method according to claim 3, further comprising:
storing first conversion relationships in advance, that the first conversion relationships define relationships among the EGR-OFF corresponding value, the engine speed in the first period, the intake air amount in the first period, and the normalized EGR-OFF corresponding value;
obtaining the normalized EGR-OFF corresponding value used for making the abnormality determination, based on an actual engine speed in the first period in which the EGR-OFF corresponding value is actually obtained, an actual intake air amount in the first period in which the EGR-OFF corresponding value is actually obtained, the actually obtained EGR-OFF corresponding value, and the first conversion relationships;
storing second conversion relationships in advance, that the second conversion relationships define relationships among the EGR-ON corresponding value, the engine speed in the second period, the intake air amount in the second period, and the normalized EGR-ON corresponding value; and
obtaining the normalized EGR-ON corresponding value used for making the abnormality determination, based on an actual engine speed in the second period in which the EGR-ON corresponding value is actually obtained, an actual intake air amount in the second period in which the EGR-ON corresponding value is actually obtained, the actually obtained EGR-ON corresponding value, and the second conversion relationships.

5. An abnormally determining system for an internal combustion engine, comprising:
a plurality of cylinders;
a plurality of EGR gas supply sections that supply EGR gas to the respective cylinders;
an abnormality determining unit that determines an abnormality in the internal combustion engine, wherein;
the abnormality determining unit obtains an amount of change in an air-fuel ratio of exhaust gas emitted from the internal combustion engine per unit time, as basic data, and obtains a change rate corresponding value that varies according to the basic data, based on the basic data;
the abnormality determining unit obtains an EGR-OFF corresponding value during shutoff of the EGR gas, as the change rate corresponding value obtained while the EGR gas is shut off, and obtains an EGR-ON corresponding value during supply of the EGR gas, as the change rate corresponding value obtained while the EGR gas is supplied;
the abnormality determining unit obtains a normalized EGR-OFF corresponding value, by converting the obtained EGR-OFF corresponding value into an EGR-OFF corresponding value to be obtained when a rotational speed of the engine in a first period in which the basic data that provides the EGR-OFF corresponding value is obtained is equal to a particular engine speed, and an intake air amount of the engine in the first period is equal to a particular intake air amount;
the abnormality determining unit obtained a normalized EGR-ON corresponding value, by converting the obtained EGR-ON corresponding value into an EGR-ON corresponding value to be obtained when the rotational speed of the engine in a second period in which the basic data that provides the EGR-ON corresponding value is obtained is equal to the particular engine speed, and the intake air amount of the engine in the second period is equal to the particular intake air amount; and
the abnormality determining unit makes an abnormality determination as to whether any of said plurality of EGR gas supply sections is in an abnormal condition in which the EGR gas supply section is blocked, based on a relationship in magnitude between the normalized EGR-OFF corresponding value and the normalized EGR-ON corresponding value.

6. The abnormality determination system for the internal combustion engine according to claim 5, wherein
the plurality of EGR gas supply sections are provided for at least two cylinders, respectively, of the plurality of cylinders included in the internal combustion engine, said plurality of cylinders are arranged to emit exhaust gas into one exhaust collecting portion of an exhaust passage of the engine, and said plurality of EGR gas supply sections are arranged to supply external EGR gas to respective combustion chambers of said at least two cylinders.

7. The abnormality determination system for the internal combustion engine according to claim 5, further comprising
an EGR gas supply control unit that executes supply of the external EGR gas through said plurality of EGR gas supply sections when an operating condition of the engine satisfies a given EGR execution condition, and stops supply of the external EGR gas when the operating condition of the engine does not satisfy the given EGR execution condition.

8. The abnormality determination system for the internal combustion engine according to claim 5, further comprising
an air-fuel ratio sensor placed in an exhaust collecting portion or a portion of the exhaust passage downstream of the exhaust collecting portion, said air-fuel ratio sensor being operable to generate an output value that varies with an air-fuel ratio of exhaust gas in the exhaust collecting portion or said portion of the exhaust passage.

9. The abnormality determination system for the internal combustion engine according to claim 5, wherein:
the abnormality determining unit stores, in advance, first conversion relationships that define relationships among the EGR-OFF corresponding value, the engine speed in the first period, the intake air amount in the first period, and the normalized EGR-OFF corresponding value;
the abnormality determining unit is configured to obtain the normalized EGR-OFF corresponding value used for making the abnormality determination, based on an actual engine speed in the first period in which the EGR-OFF corresponding value is actually obtained, an actual intake air amount in the first period in which the EGR-OFF corresponding value is actually obtained, the actually obtained EGR-OFF corresponding value, and the first conversion relationships;
the abnormality determining unit stores, in advance, second conversion relationships that define relationships among the EGR-ON corresponding value, the engine speed in the second period, the intake air amount in the second period, and the normalized EGR-ON corresponding value; and
the abnormality determining unit is configured to obtain the normalized EGR-ON corresponding value used for making the abnormality determination, based on an actual engine speed in the second period in which the EGR-ON corresponding value is actually obtained, an actual intake air amount in the second period in which the EGR-ON corresponding value is actually obtained, the actually obtained EGR-ON corresponding value, and the second conversion relationships.
